(19) United States
(12) Patent Application Publication
(10) Pub. No.: US 2002/0189421 A1
(43) Pub. Date: Dec. 19, 2002

(54) Rotary blade for a tile cutter

(76) Inventor: Akinori Ishii, Miki (JP)

Correspondence Address: KODA & ANDROLIA, Suite 3850, 2029 Century Park East, Los Angeles, CA, 90067-3024, US

(21) Appl. No.: 10/141,384

(22) Filed: May 8, 2002

(30) Foreign Application Priority Data
May 8, 2001 (JP) 2001-137531

(51) Int. Cl. B26F 3/00; B26F 3/02; B65H 35/00; B65H 35/10; B31B 1/25; B26D 3/08

(52) U.S. Cl. 83/886; 225/96.5

(57) ABSTRACT

A rotary blade for a tile cutter that includes an operating lever movable by being guided by guide rails on a base plate of the tile cutter. The rotary blade is installed on a base section of the operating lever so as to form a cut in a surface of a tile before the tile is pressed and split. The rotary blade includes a bearing assembly, an annular cutting blade and fastening rings; and the cutting blade is disposed on the outer surface of the bearing assembly, and the fastening rings are mounted on the outer surface of the bearing assembly so as to sandwich the rotary blade from both sides to hold it on the bearing assembly. The central hole of each fastening ring is tapered with a smaller diameter on the outer side of the fastening ring and a larger diameter on the inner side.

### BACKGROUND OF THE INVENTION

1. Field of the Invention

The present invention relates to a rotary blade that is installed in a tile cutter that cuts ceramic tiles to be installed and finished on, for instance, walls and floors as construction materials.

2. Prior Art

A typical convention tile cutter for cutting tiles to specified dimensions includes a base plate on which a tile to be cut is placed and guide rails that are installed in a bridge configuration on the base. An operating lever is provided on the guide rails so that the operating lever slides on the guide rails while being guided by the guide rails. The operating lever has, on the lower portion of its base section, a rotary blade, which forms a cut in the tile surface and a pressing plate that presses and splits the tile along cut.

FIG. 4 shows one example of a tile cutter of this type.

This tile cutter has a central projecting strip 2 oriented in the direction of the length of a roughly rectangular base plate 1. Tile supporting surfaces covered by bonded elastic sheets 3 are formed at roughly the same height as the projecting strip 2 on both sides of the projecting strip 2. Guide rails 4 are provided in a bridge configuration on supporting stands 5 which are installed in an upright attitude at the front and rear ends of the base plate 1. The guide rails 4 are positioned above the projecting strip 2, and a moving base 6 is installed on the guide rails 4 so that the moving base 6 slides on the guide rails 4. An operating lever 7 is hinge-connected to this moving base 6, and a rotary blade 9 that forms a cut in the surface of the tile placed on the base plate 1 is installed on the lower portion of the base section 8 of the operating lever 7. Furthermore, a pressing plate 10, which presses and splits the tile placed on the base plate 1 is provided on the lower portion of the base section 8 of the operating lever at a position adjacent to the rotary blade 9.

In U.S. Pat. No. 5,331,877, the applicant of the present application has previously proposed a rotary blade used in a tile cutter of the type described above.

As seen from FIG. 5, the rotary blade of this prior art is a combination of a bearing assembly 11 and an annular cutting blade 12. The bearing assembly 11 that is a part of this rotary blade 9 is comprised of an outer race 11a and an inner race 11b. Ball mounting sections are respectively formed between the outer and inner races 11a and 11b near both ends, and numerous bearing balls 11c are installed in the ball mounting sections so that the bearing balls are arranged in an annular configuration. A cutting blade 12 is mounted in a circumferential groove 13 formed in the center (widthwise) of the outer surface of the outer race of the bearing assembly 11.

The rotary blade 9 is mounted on the base section 8 of the operating lever by way of inserting an attachment shaft 14 into the central hole of the inner race 11b of the bearing assembly 11 without play and then by fastening this shaft 14 to the base section 8 of the operating lever 7.

In the rotary blade 9 described above, the cutting blade 12 rotates via the bearing assembly 11 when the blade tip 12a of the cutting blade 12 is caused to move by the operating lever 7 while being pressed against the tile surface from one edge to another of the tile placed on the base plate 1, thus forming a cut in the tile surface. Accordingly, when the cutting blade 12 is rolled to advance while being pressed against the tile surface by the operating lever 7, no play would occur in the cutting blade 12. Furthermore, the rotational friction is small, and the cutting blade 12 rotates smoothly. Thus, a sharp cut can be formed in the tile surface, and subsequent pressing and splitting of the tile with the pressing plate 10 is securely accomplished.

As shown in FIG. 4, the rotary blade 9 of the above-described tile cutter is positioned beneath the guide rails 4, and the pressing plate 10, which extends to both sides of the base plate 1 above the projecting strip 2 is installed in front of the rotary blade 9 in close proximity to the rotary blade 9. Accordingly, when the position at which the blade tip 12a of the cutting blade 12 presses against one edge of the tile surface placed on the base plate 1 is to be confirmed prior to the work of pressing and splitting of the tile, or when the condition of the cut is to be confirmed by following the movement of the blade tip 12a over the surface of the tile with the eyes upon moving the blade tip 12a over the surface of the tile to form a cut, such confirmations must be performed by viewing the blade tip 12a obliquely from above while avoiding the guide rails 4 and pressing plate 10.

As described above, in the rotary blade shown in FIG. 5 the ball mounting sections are respectively positioned near both ends of the outer race 11a and inner race 11b of the bearing assembly 11, the bearing balls 11c are installed within the ball mounting sections, and the annular cutting blade 12 is fastened in the circumferential groove 13 formed in the center of the outer surface of the outer race 11a of the bearing assembly 11. In this structure, the ball mounting sections that have a relatively large-diameter protrude on both sides of the cutting blade 12, and the blade tip 12a of the cutting blade 12 are located between these ball mounting sections. Accordingly, when the worker attempts to view the blade tip 12a of the cutting blade 12 pressed against the surface of the tile on the base plate 1, the ball mounting sections interfere, and the blade tip 12a is difficult to see. Consequently, when the worker seeks a clear view of the blade tip 12a, the worker must lower his head so that he can obtain a view from a low position via the gap between the ball mounting sections and the tile surface and must thus assume an unreasonable posture in order to view the blade tip 12a. This has an ill effect on the working characteristics.

### SUMMARY OF THE INVENTION

Accordingly, the object of the present invention is to provide a rotary blade for a tile cutter in which the amount of protrusion of the bearing assembly (the ball mounting sections) that protrudes on both sides of the cutting blade is minimized so that the blade tip of the cutting blade pressed against the surface of a tile on the tile cutter can be easily seen by the worker, thus allowing assured cutting of the tile along the planned cutting line.

The above object is accomplished by a unique structure of the present invention for a rotary blade used in a tile cutter in which the tile cutter includes an operating lever movable while being guided by guide rails installed in a bridge configuration on a base plate of the tile cutter and the rotary blade is installed on a lower portion of a base section of the operating lever and forms a cut in a surface of a tile before the tile is pressed and split; and in the present invention, the rotary blade comprises a bearing assembly, an annular cutting blade and fastening rings, the cutting blade is disposed in the center of an outer surface of an outer race that is a part of the bearing assembly, and the fastening rings are mounted on the outer race so that the fastening rings are positioned on both sides of the cutting blade and thus hold the cutting blade.

In this rotary blade, the bearing balls inside the bearing assembly are positioned precisely on the same plane as the axial center of the cutting blade disposed in the center of the outer surface of the outer race of the bearing assembly. Also, the bearing assembly has a configuration in which the amount of protrusion of the bearing assembly on both sides of the cutting blade is minimal. Accordingly, the worker can easily see the blade tip of the cutting blade pressed against the surface of the tile on the base plate. Thus, the rotary blade improves the working characteristics.

When assembling the rotary blade, the bearing assembly is first brought into the central hole of the cutting blade so that the cutting blade is disposed on the outer race of the bearing assembly so that the cutting blade is positioned in the center (with respect to the axial direction of the outer race) of the outer surface of the outer race, and then the fastening rings are secured tightly on the outer surface of the outer race so that the cutting blade is held between the fastening rings. Accordingly, there is no need to perform any special working on the bearing assembly, etc., the number of working steps for assembling is small, and rotary blades of uniform quality can be provided inexpensively.

In the rotary blade of the present invention, it is preferable that the inner circumferential surface of the central hole of each one of the fastening rings is formed as a tapered surface so that the central hole has a larger diameter on the inner side than the outer side of the fastening ring.

With this structure of the fastening rings, the smaller-diameter outer side portion of the central hole of each one of the fastening rings is firmly pressed against the outer surface of the outer race. Accordingly, the cutting blade disposed in the center of the outer surface of the outer race is held securely by the fastening rings that are provided securely on the outer surface of the outer race and on both sides of the cutting blade. Furthermore, the smaller-diameter outer side portion of each fastening ring functions as a supporting point, and the fastening ring incline toward the cutting blade. Accordingly, the inner side flat surfaces of the fastening rings are firmly pressed against the side surfaces of the cutting blade from opposite directions. As a result, a strong holding or sandwiching force is applied to the cutting blade by the fastening rings, and the fastening rings and cutting blade are brought into an integral single unit. In view of this, the cutting blade can be formed very thin. In other words, when the cutting blade is a two-sided cutting blade that has a cross-sectional V shape on the circumferential edge, it is possible to form a sharply angled blade edge that can form a deep cut in the tile surface with a narrow width. Accordingly, a sharp cut can be formed regardless of the type and thickness, etc. of the tile. Moreover, since the cutting blade can be thin, it is possible to conserve materials, and manufacture of the rotary blade is facilitated.

### BRIEF DESCRIPTION OF THE DRAWINGS

FIG. 1 is a partially (the lower half) cut-away front view of one embodiment of the rotary blade of the present invention;

FIG. 2 is a front view showing the manner of the rotary blade of the present invention being mounted to the base section of the operating lever of a tile cutter;

FIG. 3 is an enlarged sectional view of a portion (the upper half) of one of the fastening rings;

FIG. 4 is an overall perspective view of the tile cutter in which the rotary blade of the present invention is used; and

FIG. 5 is a sectional view of a conventional rotary blade.

### DETAILED DESCRIPTION OF THE INVENTION

An embodiment of the present invention will be described below with reference to the accompanying drawings.

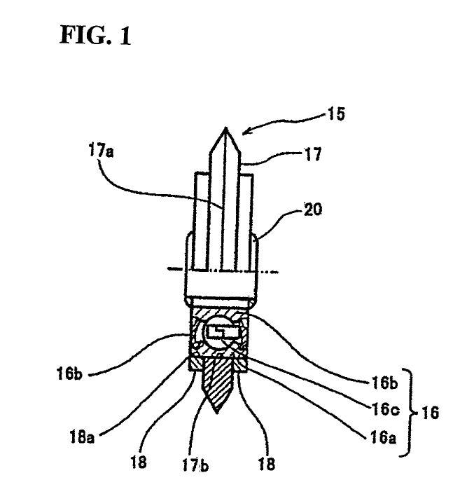

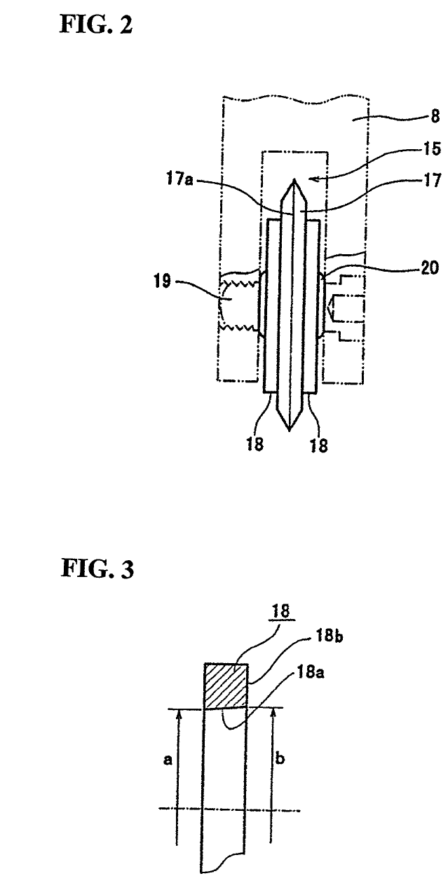

As seen from FIGS. 1 and 2, the rotary blade 15 of the present invention is comprised of a bearing assembly 16, an annular cutting blade 17, and fastening rings 18.

The bearing assembly 16 includes an outer race 16a and an inner race 16b. In the central portions of the outer and inner races 16a and 16b, recessed grooves that receive bearing balls 16c therein are respectively formed circumferentially so as to face each other. Numerous bearing balls 16c are installed in the recessed grooves so that the bearing balls are arranged in an annular configuration.

Side covers 16d are provided so as to cover the gaps created in both sides (right and left side in FIG. 1) of the outer race 16a and inner race 16b of the bearing assembly 16.

The annular cutting blade 17 is made of an ultra-hard alloy such as tungsten carbide, and it has a central hole 17b that comes into contact with the outer surface of the outer race 16a of the bearing assembly 16. A two-sided cutting blade edge 17a that has a cross-sectional V shape is formed on the circumferential edge of this cutting blade 17.

Each of the fastening rings 18, made of metal and have a substantially square cross-sectional shape with respect to its axial direction, has a central hole 18a, so that the inner surface of the central hole 18a comes into a tight contact with the outer surface of the outer race 16a of the bearing assembly 16.

As best seen from FIG. 3, the central hole 18a of the fastening ring 18 is a tapered hole that opens wider on the inner side. More specifically, the opening diameter b on the inner side (that faces the cutting blade 17) of the central hole 18a is slightly larger than the opening diameter a on the outer side (that faces opposite from the cutting blade 17) of the central hole 18a. FIG. 3 shows the fastening ring 18 that is provided on the left side of cutting blade shown in FIGS. 1 and 2, and the fastening ring 18 on the right side (not shown) appears as a mirror image of the left side fastening ring.

With the above structure, the rotary blade 15 is assembled in the following manner. First, the cutting blade 17 is disposed in the center (widthwise) of the outer surface of the outer race 16a of the bearing assembly 16. Second, the fastening rings 18 are tightly fitted on the outer surface of the outer race 16a so as to be on both sides of the cutting blade 17. The cutting blade 17 is thus securely sandwiched and held by the fastening rings 18.

When the fastening rings 18 are thus mounted, the smaller-diameter outer side portions of the central holes 18a of the fastening rings 18 are firmly pressed against the outer surface of the outer race 16a of the bearing assembly 16. As a result, the fastening rings 18 show an overall tendency to incline toward the cutting blade 17. Accordingly, the inner side flat surfaces 18b of the fastening rings 18 are strongly pressed against the side surfaces of the cutting blade 17, thus strengthening the holding force applied to the cutting blade 17 by the fastening rings 18. As a result, an integral single unit rotary blade that comprises the cutting blade 17 and the fastening rings 18 on the bearing assembly 16 is obtained.

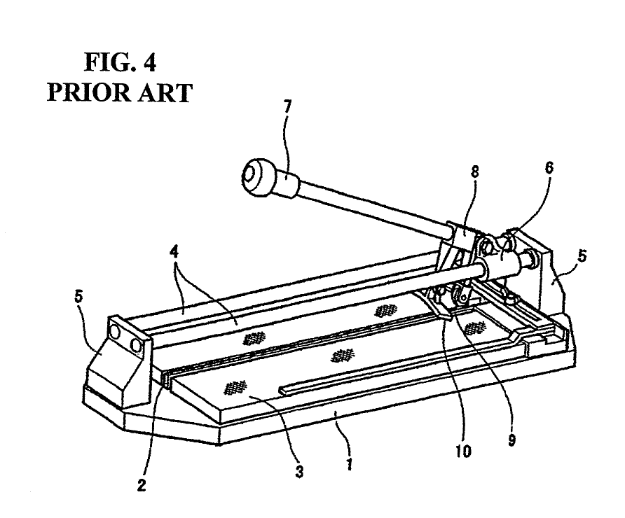

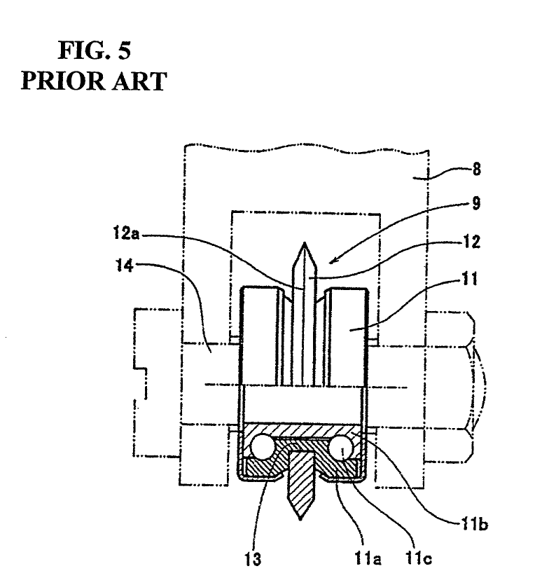

The rotary blade 15 described above is used in a tile cutter shown in FIG. 4 in place of a conventional rotary blade. In particular, a fastening screw 19 that has an angular hole is inserted in the central hole 18a of the inner race 16b of the bearing assembly 16 and fastened therein; and the fastening screw 19 is rotatably installed in the base section 8 of the operating lever 7 of the tile cutter.

In the shown embodiment, a sleeve 20 is installed in the central hole of the inner race 16b as seen from FIG. 2, so that the fastening screw 19 does not make a direct contact with the bearing assembly 16. With this sleeve 20, the bearing assembly 16 is prevented from making a direct contact with the base section 8 of the operating lever 7. Accordingly, the rotary blade 15 is mounted on the base section 8 of the operating lever 7 and rotated without any play, so that the blade 15 is pressed against the surface of a tile set on the tile cutter.

In the rotary blade described above, the center of each bearing ball 16c in the bearing assembly is positioned so as to be on the same vertical plane as (and coincide with) the center (widthwise or in the axial direction) of the cutting blade 17 disposed in the center (widthwise or in the axial direction) of the outer surface of the outer race 16a of the bearing assembly 16. In addition, the amount of outward protrusion of the bearing assembly on both sides of the cutting blade is minimized. Accordingly, the worker can easily view the blade tip of the cutting blade being pressed against the surface of a tile on the base plate of the tile cutter. Thus, the rotary blade has improved working characteristics.

Furthermore, on the outer surface of the outer race 16a of the bearing assembly 16, the cutting blade 17 is sandwiched and held by the fastening rings 18 that are tightly fitted on the outer surface the bearing assembly so as to be on both sides of the cutting blade. Accordingly, the fastening rings and the cutting blade make an integral single unit, and the cutting blade can be formed thinner compared to the prior art cutting blade. As a result, a sharply angled blade edge that can make a deep cut in the tile surface with a narrow width can be obtained. Also, a sharp cut can be formed regardless of the type and thickness of the tile, and the tile can be securely pressed and split in the next process. Thinner cutting blade of the present invention can conserve the materials, and the manufacture of the cutting blade is facilitated.

1. A rotary blade for a tile cutter in which said tile cutter includes an operating lever movable while being guided by guide rails installed in a bridge configuration on a base plate of said tile cutter and said rotary blade is installed on a lower portion of a base section of said operating lever and forms a cut in a surface of a tile before said tile is pressed and split, wherein
said rotary blade comprises a bearing assembly, an annular cutting blade and fastening rings,
said cutting blade is disposed in a center of an outer surface of an outer race of said bearing assembly, and
said fastening rings are provided on said outer race so as to be positioned on both sides of said cutting blade and hold said cutting blade.

2. The rotary blade for a tile cutter according to claim 1, wherein each of said fastening rings has a central hole of which surface is pressed against said outer surface of said outer race, and said central hole is formed tapered with a diameter thereof gradually increasing from an outer side toward an inner side of said fastening ring.
